(19) United States
(12) Patent Application Publication
(10) Pub. No.: US 2013/0299728 A1
(43) Pub. Date: Nov. 14, 2013

(54) BUTTERFLY VALVE

(71) Applicants: Masayuki Yokoyama, Tokyo (JP); Katsunori Takai, Tokyo (JP); Satoru Hasegawa, Tokyo (JP); Haruo Watanuki, Tokyo (JP)

(72) Inventors: Masayuki Yokoyama, Tokyo (JP); Katsunori Takai, Tokyo (JP); Satoru Hasegawa, Tokyo (JP); Haruo Watanuki, Tokyo (JP)

(73) Assignee: MITSUBISHI ELECTRIC CORPORATION, Tokyo (JP)

(21) Appl. No.: 13/981,139

(22) PCT Filed: Mar. 30, 2011
(86) PCT No.: PCT/JP2011/001918

§ 371 Date: Jul. 23, 2013

(51) Int. Cl. F16K 1/226

(52) U.S. Cl. CPC F16K 1/2263
USPC 251/306

(57) ABSTRACT

A thickness of a valve is set smaller than a distance (inter-seat distance) in a valve thickness direction from a first seat part to a second seat part, and hence a gap between the valve and the first seat part and a gap between the valve and the second seat part are reduced to suppress seat leakage with all a variation of dimension thereof.

### TECHNICAL FIELD

The present invention relates to a step type butterfly valve in which a valve abuts against a step provided in a fluid passage.

### BACKGROUND ART

A conventional butterfly valve has a structure in which a step serving as a valve seat is provided along the inner circumferential surface of a fluid passage, and the outer circumferential surface of the valve is formed in an inclined shape or an arc-shape in cross section; thus, the outer circumferential surface of the valve is brought into line contact with the step to thereby close the fluid passage (for example, see Patent Document 1). When the dimensions of the parts are changed by heat, a gap is liable to be created at the line contact section, resulting in the occurrence of the leakage between the valve and the seat (hereinafter, referred to as “seat leakage”). In a case where a fluid with a relatively lower temperature is flowed therethrough, the valve is formed of rubber to enhance the adhesion with the surface of the seat (for example, see Patent Document 2), or the valve is pressed against the seat by a spring member to thereby suppress the seat leakage. However, in a butterfly valve for control of a fluid at a high temperature like an EGR (Exhaust Gas Recirculation) valve through which an exhaust gas (600 to 700° C.) is circulated, parts having a lower heat resistance such as rubber and spring members cannot be employed for suppressing the seat leakage.

Thus, in order to reduce the effects of the change of the dimensions due to heat, there is a butterfly valve having a structure (so-called step type valve) such that the front and back faces of the valve are brought into surface contact with the steps that are prepared along the inner circumferential surface of the fluid passage to thereby close the fluid passage. In the butterfly valve of this type, the front face on one side of the valve and the back face on the other side thereof abut against the steps with the rotation central axis as a boundary, which provides the overlapping allowances between the front and back faces of the valve and the steps; accordingly, even when the dimensions are changed by heat, the change of the seat leakage is small.

### PRIOR ART DOCUMENTS

### Patent Documents

Patent Document 1: Japanese Patent Application Laid-open No. 2004-263723

Patent Document 2: Japanese Patent Application Laid-open No. H6-17945

### SUMMARY OF THE INVENTION

### Problems to be Solved by the Invention

In the step type butterfly valve, in order to suppress the seat leakage during valve closing, it is required to minimize the gap between the valve and the step in such a manner that the thickness of the valve, and the distance between the steps against which the front and back faces of the valve abut (inter-seat distance described later) are processed with high precision. However, there is a problem such that even when design is made to minimize the gap, the amount of the seat leakage varies largely due to a variation of dimension thereof.

Further, in the butterfly valve, in order to avoid the interference between the valve and the step (or the fluid passage) in rotation of the valve, the step cannot be formed at a portion of the inner circumferential surface of the fluid passage to be penetrated by the valve shaft. Therefore, there is a problem such that leakage occurs from the vicinity of the valve shaft.

The present invention is made to solve the aforementioned problems, and an object of the invention is to provide a butterfly valve such that the seat leakage due to the variation of dimension is suppressed.

### Means for Solving the Problems

A butterfly valve of the invention includes: a housing provided with a fluid passage; a valve shaft rotatably held by a bearing member fixed to the housing; a substantially circular valve having a valve shaft through hole for inserting the valve shaft therethrough, and rotating integrally with the valve shaft; and a valve seat being a step provided along the inner circumferential surface of the fluid passage, and having a first seat part in a semi-arc abutting against a front face of one half wing of the valve with the valve shaft through hole as a boundary, and a second seat part in a semi-arc abutting against aback face of another half wing thereof; it is configured that a thickness of the valve is smaller than a distance in a direction of the said thickness from the first seat part to the second seat part.

### Effect of the Invention

According to the invention, when the thickness of the valve is smaller than the distance in the direction of the said thickness from the first seat part to the second seat part, the gap between the valve and the seat part can be reduced even when a variation of dimension arises, and hence the seat leakage due to the variation of dimension can be suppressed.

### BRIEF DESCRIPTION OF THE DRAWINGS

FIG. 1 is a front view showing a configuration of a butterfly valve in accordance with Embodiment 1 of the present invention.

FIG. 2 is a cross-sectional view of the butterfly valve in accordance with Embodiment 1 cut along a line AA shown in FIG. 1.

FIG. 3 is a view for illustrating the seat leakage of the butterfly valve in accordance with Embodiment 1.

FIG. 4 is a view for illustrating the seat leakage of a butterfly valve in which the thickness of a valve is larger than an inter-seat distance.

FIG. 5 is a graph showing changes of a aperture area and a seat leakage amount to the difference between the valve thickness and the inter-seat distance.

FIG. 6 is a cross-sectional view of the butterfly valve in accordance with Embodiment 1 cut along a line DD shown in FIG. 2.

FIG. 7 is a plan view showing a configuration of an exhaust gas circulation valve to which the butterfly valve in accordance with Embodiment 1 is applied.

FIG. 8 is a partial cross-sectional view of the exhaust gas circulation valve shown in FIG. 7 as seen from a side direction thereof.

### BEST MODE FOR CARRYING OUT THE INVENTION

Hereinafter, in order to explain the present invention in more detail, embodiments for carrying out the invention will be described with reference to the accompanying drawings. Embodiment 1.

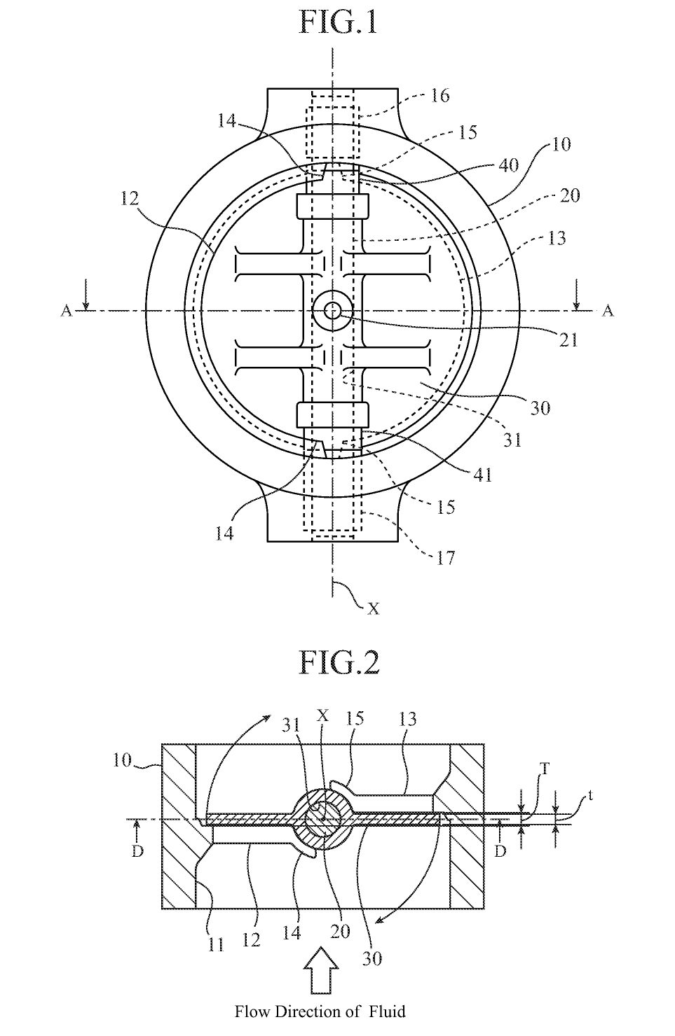

A butterfly valve shown in a front view of FIG. 1 and a cross-sectional view of FIG. 2 includes: a housing 10 interposed in a tube (not shown) for circulating a fluid therethrough; a valve shaft 20 rotatably held in the housing 10; and a valve 30 rotating integrally with the valve shaft 20 inserted through a valve shaft through hole 31 and fastened by a pin 21 to open and close a fluid passage 11.

In the following, for convenience of explanation, the face of the valve 30 facing the upstream side, and the face thereof facing the downstream side in a valve closed condition are differently referred to as “front” and “back,” respectively. However, either face thereof may be set as the front or back.

The fluid passage 11 is formed in the housing 10, and a step serving as a valve seat is formed on the inner circumferential surface of the fluid passage 11. As discussed previously, in the butterfly valve, in order to avoid the interference between the valve 30 and the valve seat in rotation of the valve 30, the valve seat cannot be placed in the vicinity of the valve shaft 20. For that reason, it is configured such that two steps in a semi-arc are provided along the inner circumferential surface of the fluid passage 11, whereas no step is provided at a section to be penetrated by the valve shaft 20. In the illustrated example, the step abutting against the front face of a half wing of the valve 30 with the valve shaft through hole 31 as a boundary of the two steps is defined as a first seat part 12, and the step abutting against the back face of another half wing thereof is defined as a second seat part 13.

As shown in FIG. 2, when the thickness of the valve 30 is defined as t, and the distance in the valve thickness direction from the first seat part 12 to the second seat part 13 is defined as an inter-seat distance T, the thickness t of the valve 30 is set smaller than the inter-seat distance T; thus, when a variation of dimension thereof occurs, an increase of the seat leakage amount from the gaps (clearance) between the valve 30 and the first seat part 12 and the second seat part 13 is suppressed.

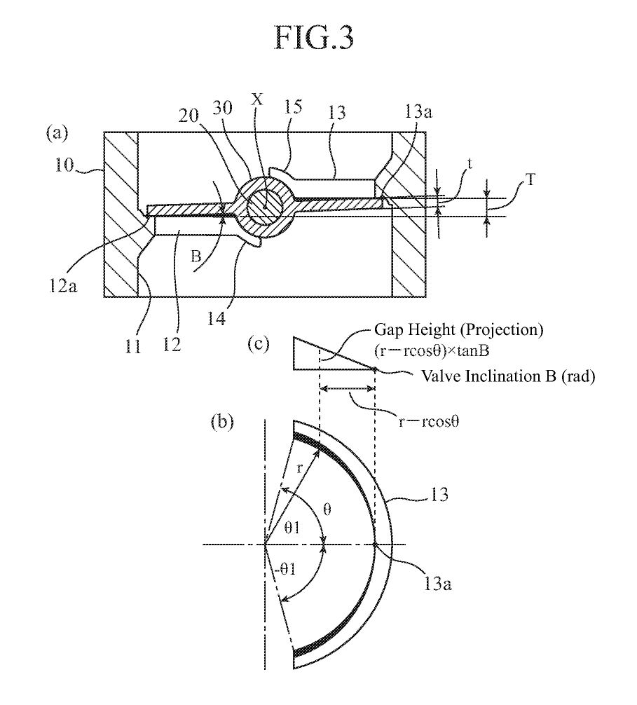

FIG. 3 is a view for illustrating the seat leakage when the variation of dimension occurs in the butterfly valve in accordance with Embodiment 1, and FIG. 3(a) shows a cross-sectional view cut at a position corresponding to a line AA of FIG. 1. Even when design is made to minimize the gaps between the valve 30 and the first seat part 12 and the second seat part 13, when the variation of dimension occurs, as indicated for abutting parts 12a and 13a in FIG. 3, the outer peripheries of the valve 30 in a direction orthogonal to a rotation central axis X abut against the first seat part 12 and the second seat part 13. For that reason, the gaps (gap areas indicated for black regions in FIG. 3) are created between the valve 30 and the first seat part 12, and between the valve 30 and the second seat part 13, respectively, which causes the seat leakage. FIG. 3(b) is a view illustrated such that the gap between the second seat part 13 and the valve 30 is replaced with an area, and FIG. 3(c) is a projected area of the gap between the second seat part 13 and the valve 30. As indicated for the black regions in FIG. 3(a)-(c), the area of the gap becomes larger with approach from the outer circumference side of the valve 30 toward the valve shaft 20 on the center side. The same also applies to the gap between the first seat part 12 and the valve 30.

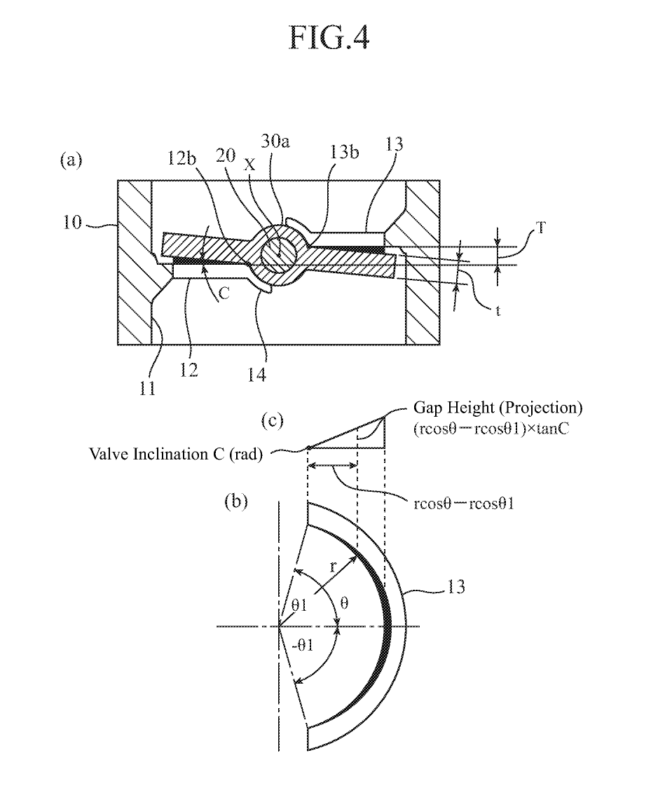

Conversely, a description will be given to a case where the thickness t of the valve is set equal to or larger than the inter-seat distance T. A reference example shown in FIG. 4 is a view for illustrating the seat leakage in a case employing a valve 30a having a thickness equal to or larger than the inter-seat distance T. In the case of the thick valve 30a, when the variation of dimension occurs, as indicated for abutting parts 12b and 13b in FIG. 4(a), the outer peripheries of the valve 30a at a position closer to the valve shaft 20 abut against the first seat part 12 and the second seat part 13. For that reason, the gaps (gap areas indicated for the black regions in FIG. 4) are created between the valve 30a and the first seat part 12, and between the valve 30a and the second seat part 13, respectively, which causes the seat leakage. FIG. 4 (b) is a view illustrated such that the gap between the second seat part 13 and the valve 30a is replaced with an area, and FIG. 4(c) is a projected area of the gap between the second seat part 13 and the valve 30a. As indicated by the black regions in FIG. 4(a) to FIG. 4(c), the area of the gap becomes larger with approach from the central side of the valve 30a that is closer to the valve shaft 20 toward the outer circumference side.

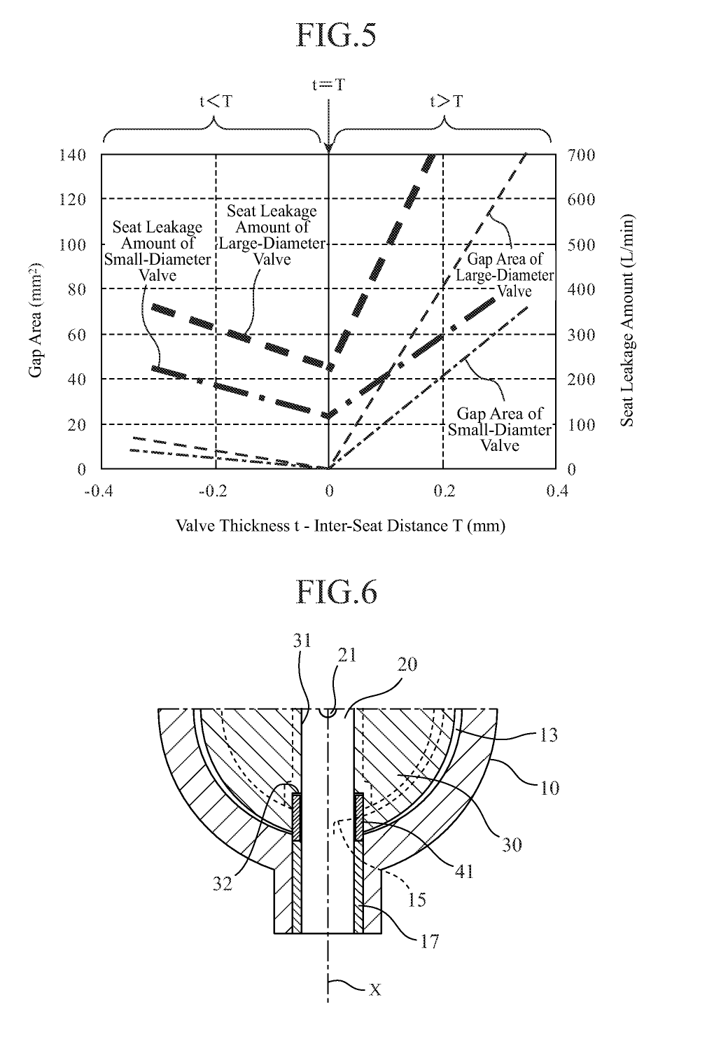

FIG. 5 is a graph showing changes of the gap area and the seat leakage amount to the difference between the valve thickness t and the inter-seat distance T. In the drawing, a horizontal axis indicates the valve thickness t—the inter-seat distance T (mm); a vertical axis on the left of the graph indicates the gap area (mm²) of the gap, and the vertical axis on the right of the graph indicates the amount seat leakage (L/min) from the gap. In this example, the gap areas and the seat leakage amounts are shown for two types of valves having relatively larger and smaller diameters, respectively. Further, the variations of dimension in this instance are assumed equal regardless of the size of the difference between the valve thickness t and the inter-seat distance T.

From the graph, in each of the larger-diameter valve (thin broken line) and the smaller-diameter valve (thin dashed line), the gap area when t>T is larger than the gap area when t<T. Therefore, in each of the larger-diameter valve (thick broken line) and the smaller-diameter valve (thick dashed line), the seat leakage amount when t>T is larger than the seat leakage amount when t<T. Accordingly, the seat leakage amount can be suppressed in such a manner that the valve thickness t is smaller than the inter-seat distance T independently of the valve diameter.

As mentioned above, in the butterfly valve, in order to avoid the interference between the valve 30 and the valve seat in rotation of the valve 30, the valve seat cannot be placed in the vicinity of the valve shaft 20. For that reason, gaps are necessarily created between both semi-arc ends of the first seat part 12 and the valve shaft 20, and between both semi-arc ends of the second seat part 13 and the valve shaft 20, respectively. Thus, as shown in FIGS. 1 and 2, both end portions of the step in a semi-arc constituting the first seat part 12 are extended along the inner circumferential surface of the fluid passage 11 to thereby form covering parts 14 enclosing a part of the outer circumferential surface of a fluid passage protruding portion of the valve shaft 20 at two places, respectively. Similarly, both end portions of the step in a semi-arc constituting the second seat part 13 are extended along the inner circumferential surface of the fluid passage 11 to thereby form covering parts 15 enclosing a part of the outer circumferential surface of the fluid passage protruding portion of the valve shaft 20 at two places, respectively. Each covering part 14 covers the gap between the valve shaft 20 and the first seat part 12, and each covering part 15 covers the gap between the valve shaft 20 and the second seat part 13, which suppresses the leakage from the gaps.

The extension distances of the covering parts 14 and 15 are set on the basis of an operation angle of the valve 30 so as to prevent these contact in rotation of the valve 30. Further, when the valve 30 is assembled in the housing 10, the following procedure is implemented: the valve 30 is inserted in an oblique direction between the opposing surfaces of the covering parts 14 and 15; then, the valve shaft 20 is inserted through the through hole of the housing 10 and the valve shaft through hole 31; and, the pin 21 is press-fit into the valve 30 and the valve shaft 20 to be secured thereto, and hence the extension distances of the covering parts 14 and 15 are required to be set in consideration of the thickness of the valve 30.

Incidentally, preferably, the surfaces of the covering parts 14 and 15 facing the valve shaft 20 are formed in a curved surface along the shape of the valve shaft 20 to thus reduce the clearance; for example, when a hole to be penetrated by the valve shaft 20 is processed in the housing 10, the curved surface shapes of the covering parts 14 and 15 are processed simultaneously.

Further, as shown in FIG. 1, tubular members 40 and 41 are mounted between the valve shaft 20 and the end portions of the valve shaft through hole 31. In a state where the valve shaft 20 is inserted through the valve shaft through hole 31, a slight gap may be created between the outer circumferential surface of the valve shaft 20 and the inner circumferential surface of the valve shaft through hole 31. In that case, the tubular members 40 and 41 fill the gap to thereby suppress the leakage of the fluid.

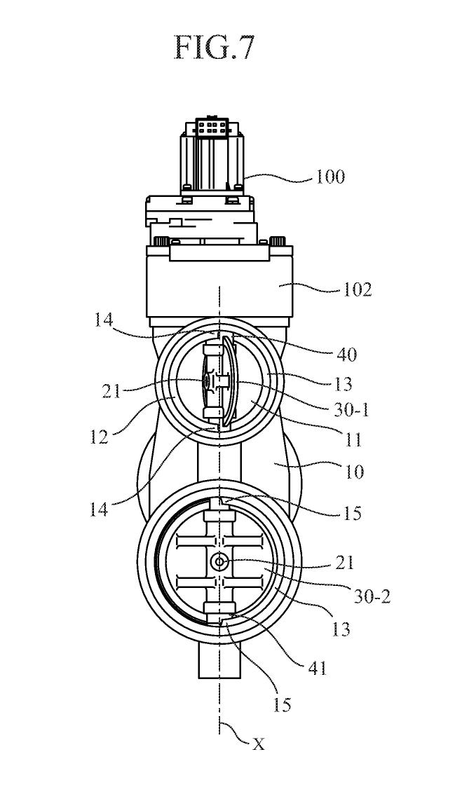

FIG. 6 is a cross-sectional view of a portion of the butterfly valve cut along a line DD shown in FIG. 2. In an example of FIG. 6, the end portion of the valve shaft through hole 31 is enlarged in diameter to form a tubular member press-fitting part 32, and a tubular member 41 is press-fit (or inserted with a small clearance) into the tubular member press-fitting part 32 to thereby fix the tubular member 41 to the valve 30. Thereafter, the valve shaft 20 is inserted through the valve shaft through hole 31, and simultaneously also inserted through the tubular member 41. The tubular member 41 fills the gap between the valve shaft 20 and the valve 30 to thereby suppress the fluid leakage. Further, the end portion of the tubular member 41 covers the outer circumferential surface of the valve shaft 20 protruding from the valve shaft through hole 31; as a result, the gap from the first seat part 12 and the gap from the second seat part 13 are filled, which can also suppress the fluid leakage from the gaps.

Although the illustration is omitted in FIG. 6, the tubular member 40 also has the same configuration as that of the tubular member 41. Incidentally, the tubular member maybe mounted on both end portions of the valve shaft through hole 31, respectively, or mounted on only any one of them.

Incidentally, when it is configured that the internal diameter of the tubular member 41 is formed slightly larger than the external diameter of the valve shaft 20 such that the valve shaft 20 can be rotated to the tubular member 41 at the time when the valve shaft 20 is inserted through the valve shaft through hole 31 and the tubular member 41, it is also possible to perform an alignment between the hole of the valve shaft 20 and the hole of the valve 30 for press-fitting of the pin 21.

Further, as shown in FIG. 1, a bearing member 17 may be placed in the housing 10 in a slightly protruding state toward the internal diameter of the fluid passage 11 such that the end faces of the protruding bearing member 17 and the tubular member 41 abut against each other. The protruding end portion of the bearing member 17 fills the gap at a portion not covered with the covering parts 14 and 15 to thereby suppress the leakage from the gap.

Further, it may also be configured that a load in the direction of the rotation central axis X is applied to the valve shaft 20, so that the tubular member 41 is rotated with abutting against the bearing member 17. In this manner, the gap between the end faces of the bearing member 17 and the tubular member 41 is eliminated; thus, the fluid becomes less likely to be leaked into the gap between the tubular member 41 and the valve shaft 20, and also the fluid becomes less likely to be leaked into the gap between the bearing member 17 and the valve shaft 20. As a result, it is possible to prevent the fluid from being leaked from the vicinity of the valve shaft 20 along the direction of the rotation central axis X to the outside. A method for applying a pressure to the valve shaft 20 will be described later.

Further, in the case of the above configuration, positioning of the valve shaft 20 integrated with the valve 30 and the tubular member 40 can also be performed by the abutting position of the tubular member 41 and the bearing member 17.

When the external diameter of the bearing member 17 is increased, the gap at the portion not covered with the covering parts 14 and 15 can be effectively filled; however, when the external diameter thereof is made equal to or larger than the external diameter of the tubular member 41, the valve 30 may come in contact with the bearing member 17 in rotation of the valve 30. For that reason, the external diameter of the bearing member 17 is preferably formed substantially equal to the external diameter of the tubular member 41.

Incidentally, although not carried out in the example of FIG. 1, it may be contemplated that the tubular member 40 and the bearing member 16 abut against each other in place of the abutting between the tubular member 41 and the bearing member 17. In this instance, it may be configured as follows: the bearing member 16 is placed in the housing 10 in a slightly protruding state toward the internal diameter of the fluid passage 11; thus, a load in the opposite direction to the above is applied to the valve shaft 20, so that the end face of the protruding bearing member 16 abuts against that of the tubular member 40.

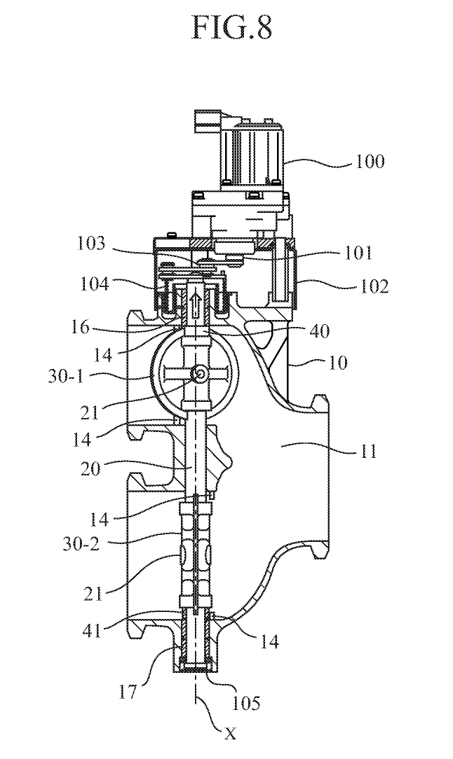

Next, a description will be given to a case where the butterfly valve in accordance with Embodiment 1 is applied to an exhaust gas circulation valve. FIG. 7 shows a plan view of the exhaust gas circulation valve, and FIG. 8 shows a fragmentary cross-sectional view thereof as seen from a side direction thereof. In the illustrated example, though the two valves 30 are installed in the single housing 10, the number thereof may be a required number. Hereinafter, for convenience of explanation, the two valves 30 are differently referred to as valves 30-1 and 30-2.

A motor 100 generates a driving force for opening and closing the valves 30-1 and 30-2, and rotates an actuator shaft 101. One end side of the actuator shaft 101 is extended in the interior of a link chamber 102 and coupled to a link 103 to thus rotate the link 103. When the link 103 is rotated by forward driving or reverse driving of the motor 100, the rotatory power of the link 103 is transmitted via a plurality of links to the valve shaft 20, so that the valves 30-1 and 30-2 fastened to the valve shaft 20 are rotated. Further, as a fail-safe, a return spring 104 is disposed on the upper end side of the valve shaft 20, and the return spring 104 urges the valve shaft 20 to thereby return the valves 30-1 and 30-2 to prescribed rotation positions. Further, the return spring 104 is wound with a wide spacing between the coils, and set in the link chamber 102 with compressed to be narrowed in the spacing. In this manner, as indicated by an arrow in FIG. 8, the valve shaft 20 is pressurized in the upward direction of the rotation central axis X under a load from the return spring 104.

In the exhaust gas circulation valve, the valve shaft 20 is inserted through the valve shaft through hole prepared in each of the valves 30-1 and 30-2, the pin 21 is press-fit into the valve shaft 20 and the valve 30-1, and the pin 21 is also press-fit into the valve shaft 20 and the valve 30-2 to be fastened thereto, respectively. In the case of this configuration, after the valve shaft 20 is inserted through the valve shaft through hole, an alignment between the pin press-fitting holes opened in the valve shaft 20 and the valves 30 is required, and hence a slight gap becomes necessary between the outer circumferential surface of the valve shaft 20 and the inner circumferential surface of the valve shaft through hole. For that reason, there is a possibility that a high-temperature gas leaks through the gap to the outside of the housing 10 (for example, link chamber 102). Also, there is also a sliding gap between the valve shaft 20 and the bearing member 16, and hence when a fluid penetrates into the gap, there is a possibility of the leakage thereof outside the housing 10. Thus, the tubular member 40 is attached at the upper-side end portion of the valve shaft through hole of the valve 30-1, the bearing member 16 facing the end portion of the tubular member 40 is protruded from the fluid passage 11, and the end face of the tubular member 40 is caused to abut against the protruding end face of the bearing member 16 by action of pressurization of the return spring 104. In such a way, the high-temperature gas circulating through the fluid passage 11 becomes less likely to penetrate from the gap between the valve shaft 20 and the tubular member 40 into the gap between the valve shaft 20 and the valve shaft through hole of the valve 30, and also becomes less likely to penetrate into the gap between the bearing member 16 and the valve shaft 20. Thus, the leakage from the vicinity of the valve shaft 20 to the outside of the housing 10 can be suppressed. It is noted that the pressurization for causing the tubular member 40 to abut against the bearing member 16 is generated at the return spring 104, which prevents an increase of the number of parts thereof.

On the other hand, on the lower end side of the rotation central axis X, there are also gaps between the tubular member 41 and the valve shaft 20, and between the bearing member 17 and the valve shaft 20; however, a cover 105 (shown in FIG. 8) is press-fit and fixed into the bottom surface of the housing 10, and hence even when the high-temperature gas leaks around the shaft, no gas leaks outside the cover 105. For this reason, in the illustrated example, no bearing member 17 abuts against the tubular member 41.

From the above, in accordance with Embodiment 1, the butterfly valve is configured to include: the housing 10 provided with the fluid passage 11; the valve shaft 20 rotatably held by the bearing members 16, 17 fixed to the housing 10; the substantially circular valve 30 having the valve shaft through hole 31 for inserting the valve shaft 20 therethrough, and rotating integrally with the valve shaft 20; and the valve seat being the step provided along the inner circumferential surface of the fluid passage 11, and having the first seat part 12 in a semi-arc abutting against the front face of the one half wing of the valve 30 with the valve shaft through hole 31 as a boundary, and the second seat part 13 in a semi-arc abutting against the back face of the another half wing thereof; further, it is contemplated that the thickness t of the valve 30 is smaller than the inter-seat distance T. For this reason, even when the variation of dimension arises, the gap between the valve 30 and the first seat part 12, and the gap between the valve 30 and the second seat part 13 can be reduced to thereby suppress the seat leakage.

In addition, in accordance with Embodiment 1, both semi-arc end portions of the first seat part 12, and both semi-arc end portions of the second seat part 13 are extended along the inner circumferential surface of the fluid passage 11 to thus form the covering parts 14 and 15 enclosing the portions of the outer circumferential surface of the valve shaft 20. For this reason, the gaps between the valve shaft 20, and the first seat part 12 and the second seat part 13 can be covered to suppress the leakage of the fluid.

Further, in accordance with Embodiment 1, the butterfly valve is configured to include the tubular members 40 and 41 attached between the end portions of the valve shaft through hole 31 and the valve shaft 20, and hence the gap between the valve shaft 20 and the valve 30 can be filled to thus suppress the fluid leakage in the direction of the rotation central axis X.

Furthermore, in accordance with Embodiment 1, the bearing members 16 and 17 are fixed to the housing 10 with the end portions of the members protruded into the fluid passage 11, and hence the end portions of the bearing members 16 and 17 fill the gaps between the valve shaft 20, and the first seat part 12 and the second seat part 13 to thus suppress the fluid leakage.

Moreover, in accordance with Embodiment 1, it is configured that any one of the tubular members 40 and 41 is rotated while abutting against the end portion of any one of the bearing members 16 and 17 protruding into the fluid passage 11 by the pressurization acting on the valve shaft 20, and hence any one of the gap between the tubular member 40 and the bearing member 16, or the gap between the tubular member 41 and the bearing member 17 can be filled to thus suppress the fluid leakage. Also, the fluid leakage from the vicinity of the valve shaft 20 to the outside of the housing 10 can be suppressed.

It is noted that in the present invention, within the scope of the invention, it is possible to modify any components in the embodiment or to omit any components in the embodiment.

### INDUSTRIAL APPLICABILITY

As described above, since the butterfly valve of the present invention is configured to suppress the seat leakage due to the variation of dimension of the step type butterfly valve, it is suitable for use in an exhaust gas circulation valve that tends to undergo dimensional changes due to heat.

### EXPLANATION OF REFERENCE NUMERALS

10 Housing, 11 Fluid passage, 12 First seat part, 13 Second seat part, 12a, 12b, 13a, 13b Abutting part, 14, 15 Covering part, 16, 17 Bearing member, 20 Valve shaft, 21 Pin, 30, 30a, 30-1, 30-2 Valve, 31 Valve shaft through hole, 32 Tubular member press-fitting part, 40, 41 Tubular member, 100 Motor, 101 Actuator shaft, 102 Link chamber, 103 Link, 104 Return spring, 105 Cover.

1. A butterfly valve, comprising:
a housing provided with a fluid passage;
a valve shaft rotatably held by a bearing member fixed to the housing;
a substantially circular valve having a valve shaft through hole for inserting the valve shaft therethrough, and rotating integrally with the valve shaft; and
a valve seat being a step provided along an inner circumferential surface of the fluid passage, and having a first seat part in a semi-arc abutting against a front face of one half wing of the valve with the valve shaft through hole as a boundary, and a second seat part in a semi-arc abutting against a back face of another half wing thereof,
wherein a thickness of the valve is smaller than an inter-seat distance from the first seat part to the second seat part.

2. The butterfly valve according to claim 1, wherein both semi-arc end portions of the first seat part, and both semi-arc end portions of the second seat part are respectively extended along the inner circumferential surface of the fluid passage to form a covering part enclosing a part of an outer circumferential surface of the valve shaft.

3. The butterfly valve according to claim 1, comprising a tubular member attached between an end portion of the valve shaft through hole and the valve shaft.

4. The butterfly valve according to claim 1, wherein the bearing member is fixed to the housing with the end portion of the member protruded into the fluid passage.

5. The butterfly valve according to claim 3, wherein the bearing member is fixed to the housing with the end portion of the member protruded into the fluid passage, and
the tubular member is rotated while abutting against the end portion of the bearing member protruded into the fluid passage by pressurization acting on the valve shaft.
